(19) United States
(12) Patent Application Publication
(10) Pub. No.: US 2025/0068901 A1
(43) Pub. Date: Feb. 27, 2025

(54) SYSTEMS AND METHODS FOR CONTROLLABLE DATA GENERATION FROM TEXT

(71) Applicant: Salesforce, Inc., San Francisco, CA (US)

(72) Inventors: Shiyu Wang, Atlanta, GA (US); Yihao Feng, Austin, TX (US); Tian Lan, Palo Alto, CA (US); Ning Yu, Palo Alto, CA (US); Yu Bai, Palo Alto, CA (US); Ran Xu, Mountain View, CA (US); Huan Wang, Palo Alto, CA (US); Caiming Xiong, Menlo Park, CA (US); Silvio Savarese, Palo Alto, CA (US)

(21) Appl. No.: 18/423,081

(22) Filed: Jan. 25, 2024

Related U.S. Application Data
(60) Provisional application No. 63/578,906, filed on Aug. 25, 2023.

(51) Int. Cl. G06N 3/08

(52) U.S. Cl. CPC G06N 3/08

(57) ABSTRACT

Embodiments described herein provide a diffusion-based framework that is trained on a dataset with limited text labels, to generate a distribution of data samples in the dataset given a specific text description label. Specifically, firstly, unlabeled data is used to train the diffusion model to generate a data distribution of data samples given a specific text description label. Then text-labeled data samples are used to finetune the diffusion model to generate data distribution given a specific text description label, thus enhancing controllability of training.

### CROSS REFERENCE(S)

The instant application is a nonprovisional of and claims priority to a co-pending and common-owned U.S. provisional application No. 63/578,906, filed Aug. 25, 2023, which is hereby expressly incorporated by reference herein in its entirety.

### TECHNICAL FIELD

The embodiments relate generally to generative artificial intelligence (AI) models and more specifically to systems and methods for controllable data generation from text in training generative AI models using unlabeled or only partially labeled datasets.

### BACKGROUND

Training generative AI models often require a large amount of training data. As annotating training data can be costly, or often require a high level of expertise in labor because of intricate data structures, the deficiency of text labels in certain areas, such as data samples of molecules, motion, and time series, limits the use of advanced generative models for text-to-data generation tasks. Thus, such lack of training labels may result in unsatisfactory training performance of generative AI models, such as model overfitting, bias, and lack of diversity.

### BRIEF DESCRIPTION OF THE DRAWINGS

FIG. 1 is a simplified diagram illustrating a text-to-data framework 100, according to embodiments described herein.

FIG. 2 is a simplified diagram illustrating an exemplary training framework 200 for a generative diffusion model (e.g., generative model in FIG. 1) for generating non-text data given a conditioning input such as a text description, according to embodiments described herein.

FIG. 3 is a simplified diagram illustrating a computing device implementing the text-to-data generation framework, according to some embodiments.

FIG. 4 is a simplified diagram illustrating a neural network structure, according to some embodiments.

FIG. 5 is a simplified block diagram of a networked system suitable for implementing the text-to-data generation framework described in FIGS. 1-2 and other embodiments described herein.

FIG. 6A is an example logic flow diagram illustrating a method of training a neural network model to transform a text description into non-textual data based on the framework shown in FIGS. 1-5, according to some embodiments described herein.

FIG. 6B illustrates an example pseudo code segment for Algorithm 1 corresponding to method shown in FIG. 6A, according to some embodiments described herein.

FIGS. 7-13 provide example data experiment performance results of the generative model trained using embodiments described in FIGS. 1-6B.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

Existing datasets that used to train generative AI models often do not have sufficient text labels for every training data sample, in particular in domains that require a high level of expertise for annotation, such as data samples of molecules, motion, and time series. Thus, such lack of training labels may result in unsatisfactory training performance of generative AI models, such as model overfitting, bias, and lack of diversity.

Some existing systems may use techniques such as data augmentation to augment training data, and/or semi-supervised training techniques that do not require fully annotated training datasets to boost training performance. However, data augmentation techniques may not always replicate genuine data fidelity to align training data samples accurately with initial text descriptions, and potentially leads to overfitting due to over-reliance on augmented samples. Data augmentation may also exacerbate training complexity, further increasing the already high computational demands of diffusion models. On the other hand, semi-supervised learning techniques may introduce nuances, ambiguities, and multiple meanings to text descriptions.

In view of the need for improved training performance of neural network models using under-labeled training datasets, embodiments described herein provide a diffusion-based framework that trains a diffusion neural network model on a dataset with limited text labels in two stages. First, the diffusion neural network model is trained using an unlabeled subset of the training dataset using unsupervised training that minimizes a first loss, resulting in a first updated set of neural network parameters. Second, the trained diffusion neural network model is then finetuned using a labeled subset of the training dataset given the specific text labels in the subset such that a second loss is minimized subject to a constraint such that a corresponding first loss term obtained using the currently updated neural network parameters is no greater than the minimized loss from the first stage. The diffusion neural network model after the two-stage training may be deployed for inference.

In one embodiment, the controllable data generation neural network framework learns the conditional data distribution conditioned on the text labels during training and subsequently draw samples from this assimilated distribution during the inference stage. For example, when the conditional data distribution of data (e.g., molecules, motions, time series, etc.) x˜p_{θ}(x|c) parameterized by θ conditioned on the text labels c is learnt during training, at inference stage, given a specific text description c=c*, the trained neural network may generate new data according to the learnt data distribution p_{θ}(x|c). Thus, new structural data such as molecules, motions, time series, etc. may be generated using a text description.

In this way, even with low-resource training data in the area of non-text data, such as molecules, motions, time series, etc., a generative model may be trained using the under labeled training data to achieve superior data generation performance. Non-text data may thus be generated using the trained generative model to efficiently transform text data to non-text data for various applications, such as protein sequencing with generative molecule data, autonomous driving with generated motion data, environment control with generated time series of environment and/or climate data, and/or the like. Neural network technology in generative AI is thus improved.

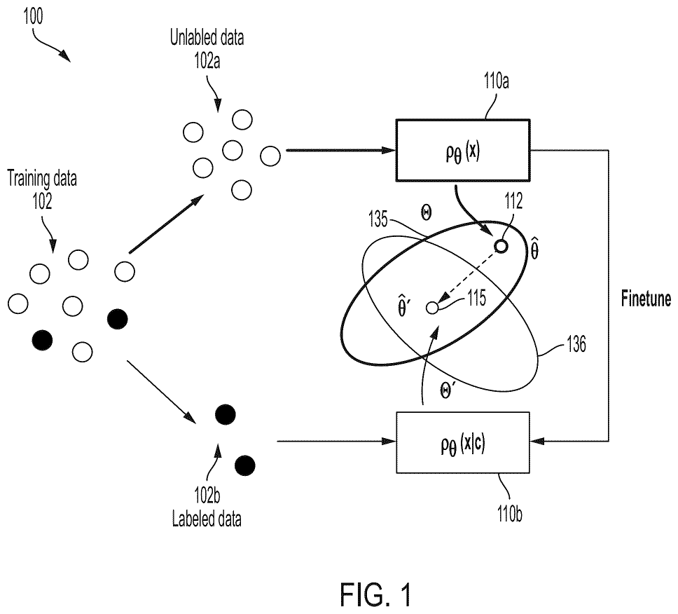

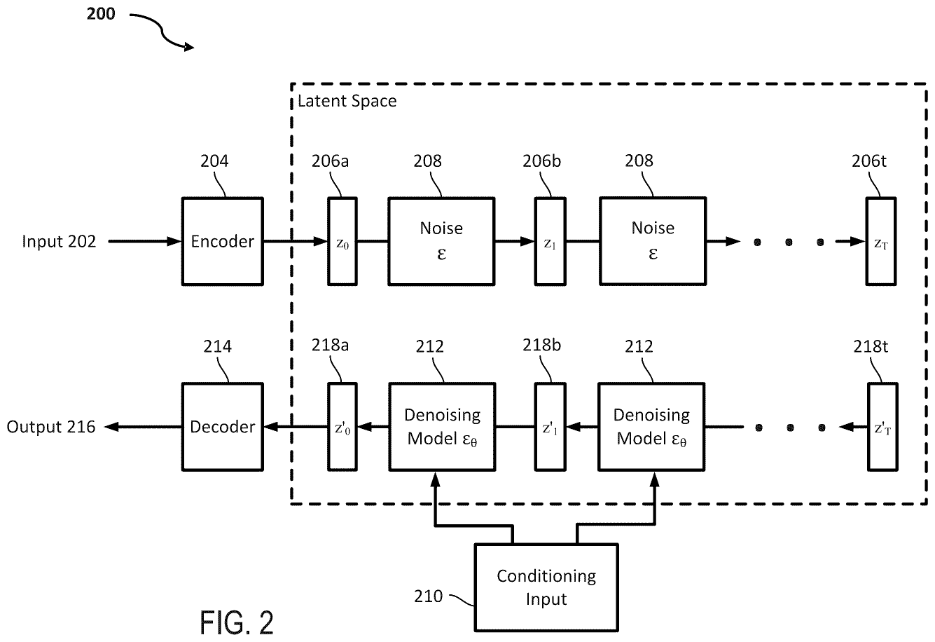

FIG. 1 is a simplified diagram illustrating a text-to-data framework 100, according to embodiments described herein. In one embodiment, a generative model 110 (also referred to as 110a and 110b as being trained in two training stages for illustrative purpose only) may be used to generate non-text data samples according to a text description. The generative model 110 may comprise a diffusion structure, e.g., the non-text data sample is generated by iteratively removing noise for multiple iterations from an initialized noisy seed vector, conditioned on a text description describing the target non-text data sample. Additional details of the diffusion generative model 110 are described in FIG. 2.

In one embodiment, a training dataset 102 [symbol] ={x, c} contains N independent non-text samples in total, where x={xᵢ}ᵢ₌₁^{N} is the non-text data samples such as molecules, motions, time series, etc. The training dataset 102 may comprise only a proportion of data 102b in x that has corresponding text description (label) c={cᵢ}ᵢ₌₁^{N}^{ₚ} where Nₚ≤N. Such labeled data with text description 102b is contained in [symbol] and [symbol] ⊂ [symbol] . Using both text-labeled data 102b and unlabeled data 102a in training dataset 102 [symbol] , a generative AI model parameterized by θ that is trained to generate data x˜p_{θ}(x|c) corresponding to a specific text description c=c*.

In one embodiment, the overall training objective is to optimize the following:

$${min}_{θ} {𝔼}_{x , c ∼ {𝒫}_{{𝒟}_{p}} ( x , c )} [ − log {p}_{θ} ( x \vert c ) ] . \qquad ( 1 )$$

While the training of a generative model is contingent upon the supervision of text descriptions present in the dataset [symbol] 102b, it is not always feasible to obtain an adequate number of data-text pairs to ensure optimal controllability (i.e., | [symbol] |<| [symbol] |), especially in specific modalities like molecular structures, motion patterns and time series.

In that case, unlabeled data 102a may be used to train the generative model parametrized by θ. For example, for an unlabeled training input data sample from the unlabeled dataset 102a, a NULL token may be used in place of an absent text label as conditions to facilitate subsequent training. Specifically, given a training input data sample x, the generative model 110a may generate a predicted distribution p_{θ}(x|Ø), where θ parameterizes the model and Ø represents the NULL token in practice. As the NULL token is independent to each data sample x, p_{θ}(x|Ø)=p_{θ}(x). Therefore, the first training stage using unlabeled data 102a optimizes the following training objective:

$${min}_{θ} {𝔼}_{x ∼ {𝒫}_{𝒟} ( x )} [ − log {p}_{θ} ( x ) ] \qquad ( 2 )$$

where [symbol] (x) is the true underlying data generating distribution. The parameters θ of the generative model may then be updated via backpropagation into model parameters \hat{θ} 112, where \hat{θ}ϵΘ and Θ 135 denotes a localized parameter space where a minimum can be located.

In one embodiment, the marginal distributions learned from unlabeled data 102a and labeled data 102b can be close, because:

$${p}_{θ} ( x ) \approx \int {p}_{θ} ( x \vert c ) p {𝒟}_{p} ( c ) dc = {𝔼}_{c ∼ p {𝒟}_{p} ( c )} [ {p}_{θ} ( x \vert c ) ] \qquad ( 3 )$$

here [symbol] (c) is the true underlying text generating distribution corresponding to xϵ [symbol] 102b. Hence, the optimal set of model parameters \hat{θ}ϵΘ updated using the unlabeled data 102a may serve as a robust approximation of p_{θ}(x|c). After the first training stage, generative model 110a parametrized by \hat{θ} may be denoted as 110b.

Then, the generative model 110b is finetuned using the data-text pairs in labeled dataset [symbol] 102b to achieve desired model controllability. Specifically, for a labeled training input data sample from the labeled dataset 102b, generative model 110b may generate a predicted data distribution p_{θ}(x|c) conditioned on the text labels in the labeled dataset 102b. The predicted data distribution p_{θ}(x|c) may then be used to compare with the text labels to compute a loss objective. The generative model 110b may then be updated via backpropagation into finetuned parameters \hat{θ}′ 115 from Θ′ 136 which is a localized parameter space where a minimum is located for \hat{θ}′ based on the loss objective. At this second stage of training (finetuning), the anticipated finetuned parameter \hat{θ}′ 115 should approximate the parameter \hat{θ} 112. Therefore, the loss objective is in fact computed as:

$${min}_{θ} {𝔼}_{x , c ∼ {p}_{{D}_{p}} ( x , c )} [ − log {p}_{θ} ( x \vert c ) ] \qquad ( 4 )$$

$$s . t . {E}_{x ∼ {𝒫}_{𝒟} ( x )} [ - log {p}_{θ} ( x ) ] \leq ξ , ξ = {inf}_{θ ∈ Θ} {𝔼}_{x ∼ {𝒫}_{𝒟} ( x )} [ − log {p}_{θ} ( x ) ]$$

where p_{D}_{ₚ}(x, c) is the true underlying data-text joint distribution. Specifically,

$${𝔼}_{x , c ∼ {p}_{{D}_{p}} ( x , c )} [ - log {p}_{θ} ( x \vert c ) ]$$

is minimized using the labeled data 120b in [symbol] within the optimal set {θ: [symbol] [−log p_{θ}(x)]≤ξ} to make the parameter 115 not far from those (112) learned from the first stage, so that catastrophic forgetting is mitigated. In other words, the parameters \hat{θ}′ 115 remain in close proximity to \hat{θ} 112 established when learning p_{θ}(x) via constraint optimization to make Eq. (3) hold to mitigate catastrophic forgetting.

In one embodiment, instead of computing a training objective in Eq. (4) at the second stage of training, the training objective may be simplified empirically:

$${min}_{θ} {ℒ}_{2} ( θ ) = s . t . {ℒ}_{1}^{′} ( θ ) \leq ξ , ξ = {inf}_{θ ∈ Θ} {ℒ}_{1} ( θ ) , \qquad ( 5 )$$

$$where$$

$${ℒ}_{1} ( θ ) = {𝔼}_{x ∼ {𝒫}_{𝒟} ( x ) , t} [ ‖ {ϵ}_{θ} ( {x}^{( t )} , t ) − ϵ {‖}^{2} ] , {ℒ}_{1}^{′} ( θ ) = {𝔼}_{x ∼ {𝒫}_{{𝒟}_{p}} t} [ {‖ {ϵ}_{θ} ( {x}^{( t )} , t ) − ϵ ‖}^{2} ] ,$$

$$and$$

$${ℒ}_{2} ( θ ) = {𝔼}_{x , c ∼ {𝒫}_{{𝒟}_{p}} ( x , c ) , t} [ {‖ {ϵ}_{θ} ( {x}^{( t )} , c , t ) − ϵ ‖}^{2} ] .$$

For a diffusion generative model 110b (details of a diffusion model are provided in FIG. 2), t is sampled from uniform between 1 and T, T is the total number of diffusion steps, e is the standard Gaussian random variable, and ϵ_{θ}(xᵢ^{(t)}, t), t) and ϵ_{θ}(xᵢ^{(t)}c, t) are functions we aim to fit at the t-th diffusion step. Note here that ϵ_{θ}(xᵢ^{(t)}, t) and ϵ_{θ}(xᵢ^{(t)}c, t) share the same parameter but are just trained at different stages: distribution mastery on unlabeled data and controllable finetuning on labeled data, respectively.

In one embodiment, as the true generating distributions [symbol] (x), [symbol] (x) and [symbol] (x, c), are unknown, an empirical loss may be computed:

$${min}_{θ} {ℒ}_{2} ( θ ) = s . t . {ℒ}_{1}^{′} ( θ ) \leq ξ , ξ = {inf}_{θ ∈ Θ} {\hat{ℒ}}_{1} ( θ ) , \qquad ( 6 )$$

$$where$$

$${\hat{ℒ}}_{1} ( θ ) = {𝔼}_{x ∼ {\hat{p}}_{𝒟} ( x ) , t} [ ‖ {ϵ}_{θ} ( {x}^{( t )} , t ) − ϵ {‖}^{2} ] , {\hat{ℒ}}_{1}^{′} ( θ ) = {𝔼}_{x ∼ {\hat{p}}_{{𝒟}_{p}} ( x ) , t} [ {‖ {ϵ}_{θ} ( {x}^{( t )} , t ) − ϵ ‖}^{2} ] ,$$

$$and$$

$${\hat{ℒ}}_{2} ( θ ) = {𝔼}_{x , c ∼ {\hat{p}}_{{𝒟}_{p}} ( x , c ) , t} [ {‖ {ϵ}_{θ} ( {x}^{( t )} , c , t ) − ϵ ‖}^{2} ] .$$

\hat{Θ} is the localized parameter space where a minimum can be located for [symbol] (θ). The lexicographic optimization-based constraint

$$ξ = {inf}_{θ ∈ \hat{Θ}} {\hat{ℒ}}_{1} ( θ )$$

in Eq. 6 may be overly strict and could require relaxation to ease the training process. In some scenarios, the parameters derived from Eq. (6) are expected to be close to those from Eq. (5).

FIG. 2 is a simplified diagram illustrating an exemplary training framework 200 for a generative diffusion model (e.g., generative model 110 in FIG. 1) for generating non-text data given a conditioning input such as a text description, according to embodiments described herein. In some embodiments, a generative diffusion model (such as generative model 110 in FIG. 1) is trained or pre-trained according to training framework 200. In one embodiment, a denoising diffusion model is trained to generate non-text data (e.g., output 216) based on a user input (e.g., a text description in conditioning input 210).

At inference, the denoising diffusion model 212 (such as the trained generative model 110 after the first and second training stages described in FIG. 1) may receive a text prompt describing the non-text data such as a molecule, a time series, a motion, and/or the like, and start with a random noise vector as a seed vector, and the denoising model progressively removes “noise” from the seed vector as conditioned by the user input (e.g., a text description) such that the resulting non-text data may gradually align with the user input. Completely removing the noise in a single step would be infeasibly difficult computationally. For this reason, the denoising model is trained to remove a small amount of noise, and the denoising step is repeated iteratively so that over a number of iterations (e.g., 50 iterations), the non-text data eventually becomes clear.

Framework 200 illustrates how such a diffusion model may be trained to generate a non-text data sample given a text prompt by gradually removing noise from a seed vector. The top portion of the illustrated framework 200 including encoder 204 and the noise ε 208 steps may only be used during the training process, and not at inference, as described below. For example, a training dataset may include a variety of non-text data samples, which do not necessarily require any annotations, such as the training dataset 102 in FIG. 1. Some labeled training data in the labeled dataset 102b may be associated with information such as a caption for some non-text data samples in the training dataset that may be used as a conditioning input 210. A training non-text data sample x may be used as input 202. Encoder 204 may encode input 202 into a latent representation (e.g., a vector) which represents the non-text data sample.

In one embodiment, latent vector representation z₀ 206a represents the first encoded latent representation of input 202. Noise ¿ 208 is added to the representation z₀ 206a to produce representation z₁ 206b. Noise ε 208 is then added to representation z₁ 206b to produce an even noisier representation. This process is repeated T times (e.g., 50 iterations) until it results in a noised latent representation z_{T} 206t. The random noise ε 208 added at each iteration may be a random sample from a probability distribution such as Gaussian distribution. The amount (i.e., variance) of noise ε 208 added at each iteration may be constant, or may vary over the iterations. The amount of noise ε 208 added may depend on other factors such as non-text data size or resolution.

This process of incrementally adding noise to latent non-text data representations effectively generates training data that is used in training the diffusion denoising model 212, as described below. As illustrated, denoising model ε_{θ} 212 is iteratively used to reverse the process of noising latents (i.e., perform reverse diffusion) from z′_{T} 218t to z′₀ 218a. Denoising model ε_{θ} 212 may be a neural network based model, which has parameters that may be learned. Input to denoising model ε_{θ} 212 may include a noisy latent representation (e.g., noised latent representation z_{T} 206t), and conditioning input 210 such as a text prompt describing desired content of an output non-text data, e.g., “a hand holding a globe.” As shown, the noisy latent representation may be repeatedly and progressively fed into denoising model 212 to gradually remove noise from the latent representation vector based on the conditioning input 210, e.g., from z′_{T} 218t to z′₀ 218a.

Ideally, the progressive outputs of repeated denoising models ε_{θ} 212 z′_{T} 218t to z′₀ 218a may be an incrementally denoised version of the input latent representation z′_{T} 218t, as conditioned by a conditioning input 210. The latent non-text data representation produced using denoising model ε_{θ} 212 may be decoded using decoder 214 to provide an output 216 which is the denoised non-text data.

In one embodiment, the output non-text data sample 216 is then compared with the input training non-text data 202 to compute a loss for updating the denoising model 212 via back propagation. In another embodiment, the latent representation 206a of input 202 may be compared with the denoised latent representation 218a to compute a loss for training. In another embodiment, a loss objective may be computed comparing the noise actually added (e.g., by noise ε 208) with the noise predicted by denoising model ε_{θ} 212. In some embodiments, the training loss objectives may be computed, depending on the stage of training and/or whether empirical approximation is used, according to Eq. (2), (4), (5) or (6) described in relation to FIG. 1.

Denoising model ε_{θ} 212 may be trained based on loss objectives (e.g., parameters of denoising model ε_{θ} 212 may be updated in order to minimize the loss by gradient descent using backpropagation). Note that this means during the training process of denoising model ε_{θ} 212, an actual denoised non-text data does not necessarily need to be produced (e.g., output 216 of decoder 214), as the loss is based on each intermediate noise estimation, not necessarily the final non-text data.

In one embodiment, conditioning input 210 may include a description of the input non-text data 202 such as a text label associated with a labeled data sample in labeled dataset 102b, or a NULL token for an unlabeled data sample in unlabeled dataset 102a. In this way, denoising model ε_{θ} 212 learns to reproduce the non-text data described. Alternatively (or in addition), conditioning input 210 may include a text prompt, a conditioning non-text data, an attention map, or other conditioning inputs. These inputs may be encoded in some way before being used by denoising model ε_{θ} 212. For example, a conditioning non-text data may be encoded using an encoder similar to encoder 204. Conditioning input 210 may also include a time step, which may be used to provide the model with a general estimate of how much noise remains in the non-text data, and the time step may increment (or decrement) for each iteration.

In one embodiment, the direct output of denoising model ε_{θ} 212 may be an estimation of the noise present in the input latent representation, or more generally a noise distribution. In this sense, the direct output may not by a latent representation of an non-text data, but rather of the noise. Using this estimated noise, however, an incrementally denoised non-text data representation may be produced which may be an input to the next iteration of denoising model ε_{θ} 212.

At inference, denoising model ε_{θ} 212 may be used to denoise a latent non-text data representation given a conditioning input 210. Rather than a noisy latent non-text data representation z_{T} 206t, the input to the sequence of denoising models may be a randomly generated vector which is used as a seed. Different non-text data samples may be generated by providing different random starting seeds. The resulting denoised latent non-text data representation after T denoising model steps may be decoded by a decoder (e.g., decoder 214) to produce an output 216 of a denoised non-text data. For example, conditioning input may include a description of an non-text data, and the output 216 may be an non-text data which is aligned with that description.

Note that while denoising model ε_{θ} 212 is illustrated as the same model being used iteratively, distinct models may be used at different steps of the process. Further, note that a “denoising diffusion model” may refer to a single denoising model ε_{θ} 212, a chain of multiple denoising models æe 212, and/or the iterative use of a single denoising model ¿e 212. A “denoising diffusion model” may also include related features such as decoder 214, any pre-processing that occurs to conditioning input 210, etc. This framework 200 of the training and inference of a denoising diffusion model may further be modified to provide improved results and/or additional functionality, for example as in embodiments described herein.

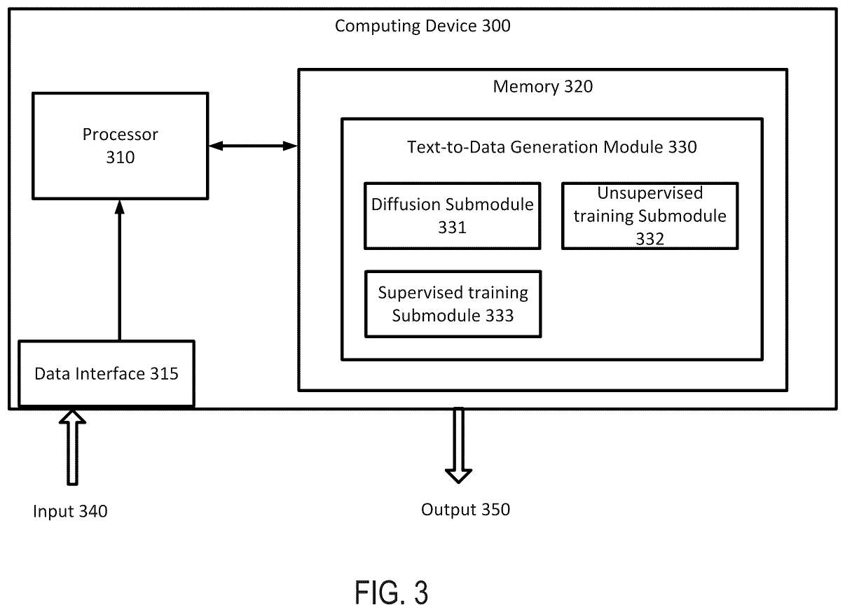

FIG. 3 is a simplified diagram illustrating a computing device implementing the diffusion-based framework, according to one embodiment described herein. As shown in FIG. 3, computing device 300 includes a processor 310 coupled to memory 320. Operation of computing device 300 is controlled by processor 310. And although computing device 300 is shown with only one processor 310, it is understood that processor 310 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 300. Computing device 300 may be implemented as a stand-alone subsystem, as a board added to a computing device, and/or as a virtual machine.

Memory 320 may be used to store software executed by computing device 300 and/or one or more data structures used during operation of computing device 300. Memory 320 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 310 and/or memory 320 may be arranged in any suitable physical arrangement. In some embodiments, processor 310 and/or memory 320 may be implemented on a same board, in a same package (e.g., system-in-package), on a same chip (e.g., system-on-chip), and/or the like. In some embodiments, processor 310 and/or memory 320 may include distributed, virtualized, and/or containerized computing resources. Consistent with such embodiments, processor 310 and/or memory 320 may be located in one or more data centers and/or cloud computing facilities.

In some examples, memory 320 may include non-transitory, tangible, machine readable media that includes executable code that when run by one or more processors (e.g., processor 310) may cause the one or more processors to perform the methods described in further detail herein. For example, as shown, memory 320 includes instructions for text-to-data generation module 330 that may be used to implement and/or emulate the systems and models, and/or to implement any of the methods described further herein. text-to-data generation module 330 may receive input 340 such as an input training data (e.g., a training dataset that is only partially annotated with text labels) via the data interface 315 and generate an output 350 which may be a data distribution of the data samples. For another example, memory 320 may store parameters, structures and/or weights of one or more neural networks such as the diffusion submodule 331, training dataset 102 in FIG. 1, and/or the like.

The data interface 315 may comprise a communication interface, a user interface (such as a voice input interface, a graphical user interface, and/or the like). For example, the computing device 300 may receive the input 340 (such as a training dataset 102 in FIG. 1) from a networked database via a communication interface. Or the computing device 300 may receive the input 340, such as a data sample that is annotated or unannotated with text labels, from a user via the user interface.

In some embodiments, the text-to-data generation module 330 is configured to generate a distribution of non-text data given a specific text label. The text-to-data generation module 330 may further include a diffusion submodule 331 (e.g., similar to generative model 110 in FIG. 1), an unsupervised training submodule 332 and a supervised training submodule 333. For example, the unsupervised training submodule 332 may be configured to train the diffusion submodule 331 using unlabeled data 102a in FIG. 1. For example, the supervised training submodule 333 may be configured to train the diffusion submodule 331 using labeled data 102b in FIG. 1.

Some examples of computing devices, such as computing device 300 may include non-transitory, tangible, machine readable media that include executable code that when run by one or more processors (e.g., processor 310) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

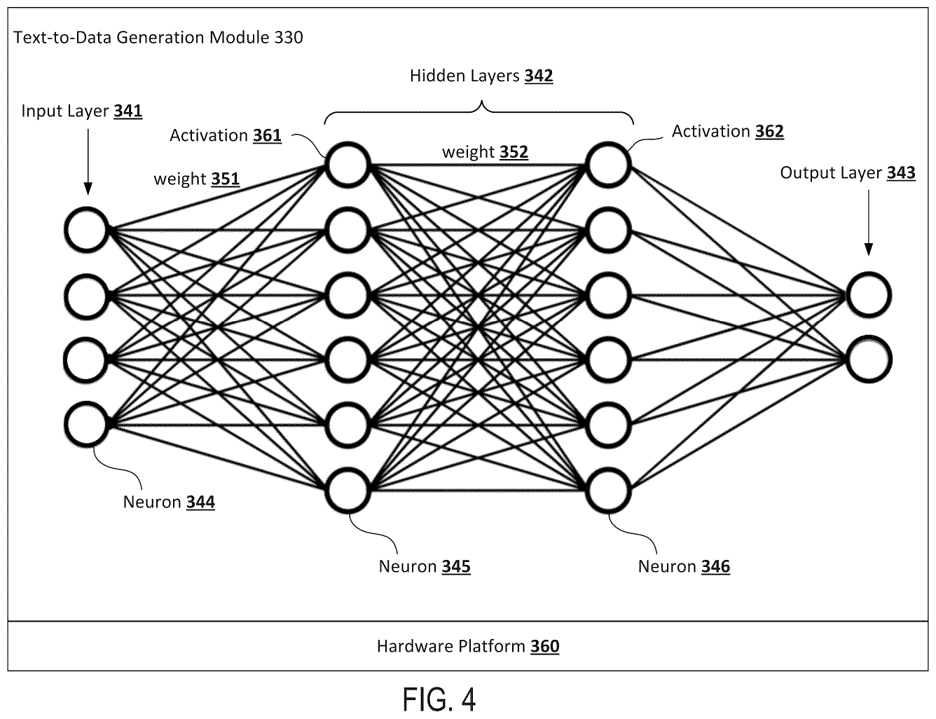

FIG. 4 is a simplified diagram illustrating the neural network structure implementing the text-to-data generation module 330 described in FIG. 3A, according to some embodiments. In some embodiments, the text-to-data generation module 330 and/or one or more of its submodules 331-133 may be implemented at least partially via an artificial neural network structure shown in FIG. 3B. The neural network comprises a computing system that is built on a collection of connected units or nodes, referred to as neurons (e.g., 344, 345, 346). Neurons are often connected by edges, and an adjustable weight (e.g., 351, 352) is often associated with the edge. The neurons are often aggregated into layers such that different layers may perform different transformations on the respective input and output transformed input data onto the next layer.

For example, the neural network architecture may comprise an input layer 341, one or more hidden layers 342 and an output layer 343. Each layer may comprise a plurality of neurons, and neurons between layers are interconnected according to a specific topology of the neural network topology. The input layer 341 receives the input data (e.g., 340 in FIG. 3), such as a training data sample representing a molecule, a time series, a motion, and/or the like. The number of nodes (neurons) in the input layer 341 may be determined by the dimensionality of the input data (e.g., the length of a vector of a data sample representing a molecule, a time series, a motion, and/or the like). Each node in the input layer represents a feature or attribute of the input.

The hidden layers 342 are intermediate layers between the input and output layers of a neural network. It is noted that two hidden layers 342 are shown in FIG. 3B for illustrative purpose only, and any number of hidden layers may be utilized in a neural network structure. Hidden layers 342 may extract and transform the input data through a series of weighted computations and activation functions.

For example, as discussed in FIG. 3, the text-to-data generation module 330 receives an input 340 of data sample representing a molecule, a time series, a motion, and/or the like and transforms the input into an output 350 of a distribution of the input data sample given a specific text label. To perform the transformation, each neuron receives input signals, performs a weighted sum of the inputs according to weights assigned to each connection (e.g., 351, 352), and then applies an activation function (e.g., 361, 362, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 341 is transformed into rather different values indicative data characteristics corresponding to a task that the neural network structure has been designed to perform.

The output layer 343 is the final layer of the neural network structure. It produces the network's output or prediction based on the computations performed in the preceding layers (e.g., 341, 342). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the text-to-data generation module 330 and/or one or more of its submodules 331-133 may comprise the transformative neural network structure of layers of neurons, and weights and activation functions describing the non-linear transformation at each neuron. Such a neural network structure is often implemented on one or more hardware processors 310, such as a graphics processing unit (GPU). An example neural network may be a diffusion model, and/or the like.

In one embodiment, the text-to-data generation module 330 and its submodules 331 may be implemented by hardware, software and/or a combination thereof. For example, the text-to-data generation module 330 and its submodules 331 may comprise a specific neural network structure implemented and run on various hardware platforms 360, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 360 used to implement the neural network structure is specifically configured based on factors such as the complexity of the neural network, the scale of the tasks (e.g., training time, input data scale, size of training dataset, etc.), and the desired performance.

In one embodiment, the neural network based text-to-data generation module 330 and one or more of its submodules 331-133 may be trained by iteratively updating the underlying parameters (e.g., weights 351, 352, etc., bias parameters and/or coefficients in the activation functions 361, 362 associated with neurons) of the neural network based on the loss described in Eqs. (3), (4), (5) and (6). For example, during forward propagation, the training data such as data sample representing a molecule, a time series, a motion, and/or the like are fed into the neural network. The data flows through the network's layers 341, 342, with each layer performing computations based on its weights, biases, and activation functions until the output layer 343 produces the network's output 350. In some embodiments, output layer 343 produces an intermediate output on which the network's output 350 is based.

The output generated by the output layer 343 is compared to the expected output (e.g., a “ground-truth” such as the corresponding labeled data samples with text labels) from the training data, to compute a loss function that measures the discrepancy between the predicted output and the expected output. For example, the loss function may be Eqs. (3), (4), (5) and (6). Given the loss, the negative gradient of the loss function is computed with respect to each weight of each layer individually. Such negative gradient is computed one layer at a time, iteratively backward from the last layer 343 to the input layer 341 of the neural network. These gradients quantify the sensitivity of the network's output to changes in the parameters. The chain rule of calculus is applied to efficiently calculate these gradients by propagating the gradients backward from the output layer 343 to the input layer 341.

Parameters of the neural network are updated backwardly from the last layer to the input layer (backpropagating) based on the computed negative gradient using an optimization algorithm to minimize the loss. The backpropagation from the last layer 343 to the input layer 341 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as an unseen data sample representing a molecule, a time series, a motion, and/or the like.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

Therefore, the training process transforms the neural network into an “updated” trained neural network with updated parameters such as weights, activation functions, and biases. The trained neural network thus improves neural network technology in natural language processing, genome sequencing (e.g., data samples of molecules, etc.), autonomous driving (e.g., data samples of time series of motion pictures, and/or the like), and/or the like.

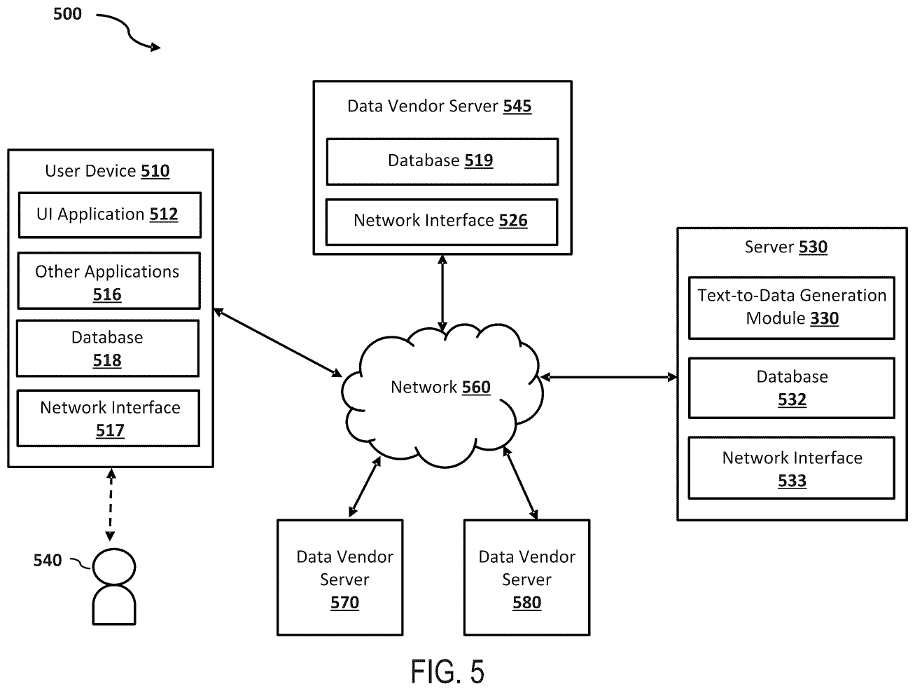

FIG. 5 is a simplified block diagram of a networked system 500 suitable for implementing the text-to-data generation framework described in FIGS. 1-2 and other embodiments described herein. In one embodiment, system 500 includes the user device 510 which may be operated by user 540, data vendor servers 545, 570 and 580, server 530, and other forms of devices, servers, and/or software components that operate to perform various methodologies in accordance with the described embodiments. Exemplary devices and servers may include device, stand-alone, and enterprise-class servers which may be similar to the computing device 100 described in FIG. 1A, operating an OS such as a MICROSOFT® OS, a UNIX® OS, a LINUX® OS, or other suitable device and/or server-based OS. It can be appreciated that the devices and/or servers illustrated in FIG. 5 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 510, data vendor servers 545, 570 and 580, and the server 530 may communicate with each other over a network 560. User device 510 may be utilized by a user 540 (e.g., a driver, a system admin, etc.) to access the various features available for user device 510, which may include processes and/or applications associated with the server 530 to receive an output data anomaly report.

User device 510, data vendor server 545, and the server 530 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 500, and/or accessible over network 560.

User device 510 may be implemented as a communication device that may utilize appropriate hardware and software configured for wired and/or wireless communication with data vendor server 545 and/or the server 530. For example, in one embodiment, user device 510 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 510 of FIG. 5 contains a user interface (UI) application 512, and/or other applications 516, which may correspond to executable processes, procedures, and/or applications with associated hardware. For example, the user device 510 may receive a message indicating a data distribution from the server 530 and display the message via the UI application 512. In other embodiments, user device 510 may include additional or different modules having specialized hardware and/or software as required.

In various embodiments, user device 510 includes other applications 516 as may be desired in particular embodiments to provide features to user device 510. For example, other applications 516 may include security applications for implementing client-side security features, programmatic client applications for interfacing with appropriate application programming interfaces (APIs) over network 560, or other types of applications. Other applications 516 may also include communication applications, such as email, texting, voice, social networking, and IM applications that allow a user to send and receive emails, calls, texts, and other notifications through network 560. For example, the other application 516 may be an email or instant messaging application that receives a prediction result message from the server 530. Other applications 516 may include device interfaces and other display modules that may receive input and/or output information. For example, other applications 516 may contain software programs for asset management, executable by a processor, including a graphical user interface (GUI) configured to provide an interface to the user 540 to view a data distribution of a dataset.

User device 510 may further include database 518 stored in a transitory and/or non-transitory memory of user device 510, which may store various applications and data and be utilized during execution of various modules of user device 510. Database 518 may store user profile relating to the user 540, predictions previously viewed or saved by the user 540, historical data received from the server 530, and/or the like. In some embodiments, database 518 may be local to user device 510. However, in other embodiments, database 518 may be external to user device 510 and accessible by user device 510, including cloud storage systems and/or databases that are accessible over network 560.

User device 510 includes at least one network interface component 517 adapted to communicate with data vendor server 545 and/or the server 530. In various embodiments, network interface component 517 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 545 may correspond to a server that hosts database 519 to provide training datasets including data samples representing a molecule, a time series, a motion, and/or the like, with or without text labels, to the server 530. The database 519 may be implemented by one or more relational database, distributed databases, cloud databases, and/or the like.

The data vendor server 545 includes at least one network interface component 526 adapted to communicate with user device 510 and/or the server 530. In various embodiments, network interface component 526 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 545 may send asset information from the database 519, via the network interface 526, to the server 530.

The server 530 may be housed with the text-to-data generation module 330 and its submodules described in FIG. 3. In some implementations, text-to-data generation module 130 may receive data from database 519 at the data vendor server 545 via the network 560 to generate a data distribution given a text label. The generated data distribution may also be sent to the user device 510 for review by the user 540 via the network 560.

The database 532 may be stored in a transitory and/or non-transitory memory of the server 530. In one implementation, the database 532 may store data obtained from the data vendor server 545. In one implementation, the database 532 may store parameters of the text-to-data generation module 130. In one implementation, the database 532 may store previously generated data distribution of datasets, and the corresponding input feature vectors.

In some embodiments, database 532 may be local to the server 530. However, in other embodiments, database 532 may be external to the server 530 and accessible by the server 530, including cloud storage systems and/or databases that are accessible over network 560.

The server 530 includes at least one network interface component 533 adapted to communicate with user device 510 and/or data vendor servers 545, 570 or 580 over network 560. In various embodiments, network interface component 533 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 560 may be implemented as a single network or a combination of multiple networks. For example, in various embodiments, network 560 may include the Internet or one or more intranets, landline networks, wireless networks, and/or other appropriate types of networks. Thus, network 560 may correspond to small scale communication networks, such as a private or local area network, or a larger scale network, such as a wide area network or the Internet, accessible by the various components of system 500.

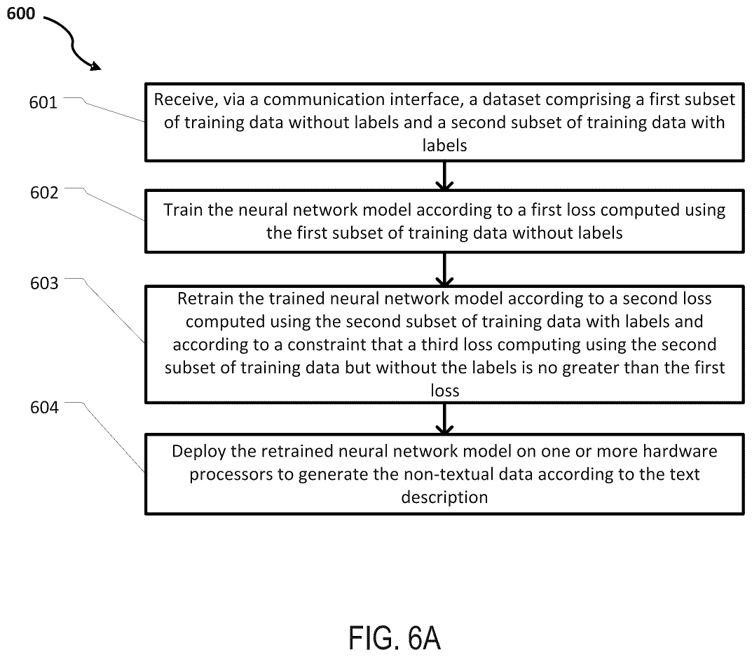

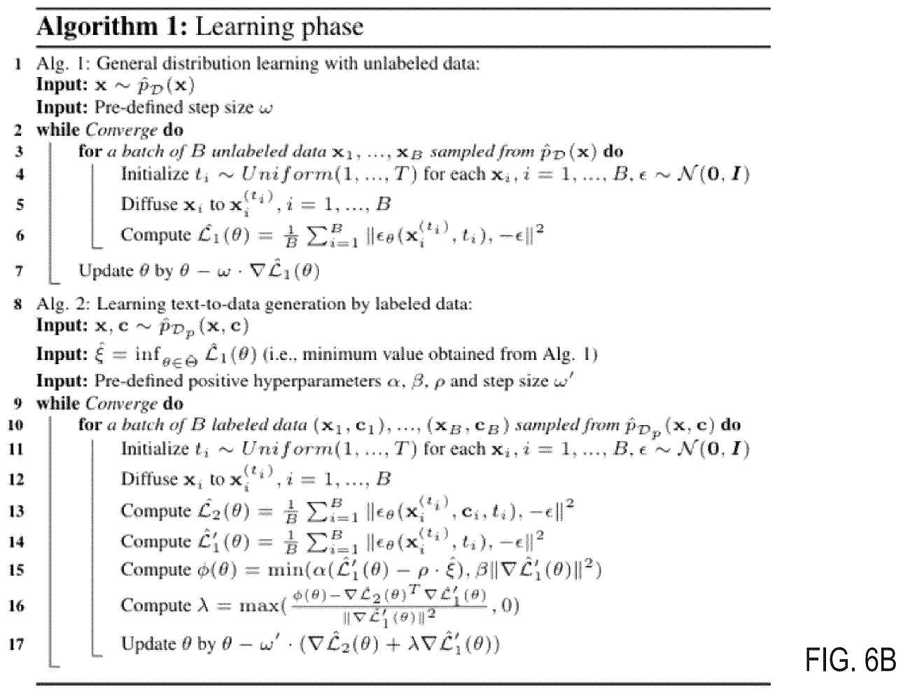

FIG. 6A is an example logic flow diagram illustrating a method 600 of training a neural network model to transform a text description into non-textual data based on the framework shown in FIGS. 1-5, according to some embodiments described herein. Correspondingly, FIG. 6B illustrates an example Algorithm 1 corresponding to method 600. One or more of the processes of method 600 may be implemented, at least in part, in the form of executable code stored on non-transitory, tangible, machine-readable media that when run by one or more processors may cause the one or more processors to perform one or more of the processes. In some embodiments, method 600 corresponds to the operation of the text-to-data generation module 330 (e.g., FIGS. 3 and 5) that generate non-text data based on a text description.

As illustrated, the method 600 includes a number of enumerated steps, but aspects of the method 600 may include additional steps before, after, and in between the enumerated steps. In some aspects, one or more of the enumerated steps may be omitted or performed in a different order.

At step 601, a dataset (e.g., training data 102 in FIG. 1) comprising a first subset of training data without labels (e.g., unlabeled data 102a in FIG. 1) and a second subset of training data with labels (e.g., labeled data 102b in FIG. 1) may be received, via a communication interface (e.g., interface 315 in FIG. 3, network interface 533 in FIG. 5), e.g., line 1 in Algorithm 1 of FIG. 6B.

At step 602, the neural network model (e.g., generative model 110 in FIG. 1 which may be a diffusion model shown in FIG. 2) may be trained according to a first loss (e.g., Eq. (2)) computed using the first subset of training data without labels. For example, training a diffusion model, as depicted in FIG. 2, may comprise adding a noise term to a training data sample from the first subset to generate a noised sample (e.g., iteratively from t=1, . . . , T as shown at 206a-206t in FIG. 2), and iteratively predicting, by the diffusion model (e.g., 212 in FIG. 2), a first predicted noise term from the noised sample, e.g., lines 4-5 in Algorithm 1 of FIG. 6B. The first loss is computed based on a difference between the first predicted noise term and the added noise term, e.g., [symbol] (θ)= [symbol] [∥ϵ_{θ}(x^{(t)}, t)−ϵ∥²], e.g., line 6 in Algorithm 1 of FIG. 6B. Parameters of the neural network are then updated based on the first loss, e.g., line 7 in Algorithm 1 of FIG. 6B.

At step 603, the trained neural network model (e.g., generative model 110a with updated parameters 112) may be retrained according to a second loss (e.g., Eq. (4), (5), (6)) computed using the second subset of training data with labels and according to a constraint that a third loss computing using the second subset of training data but without the labels is no greater than the first loss. For example, retraining the diffusion model may comprise: adding a noise term to a training data sample from the second subset to generate a noised sample (e.g., iteratively from t=1, . . . , T as shown at 206a-206t in FIG. 2), iteratively predicting, by the diffusion model (e.g., 212 in FIG. 2), a second predicted noise term from the noised sample, e.g., ϵ_{θ}(x^{(t)}, t), and iteratively predicting, by the diffusion model, a third predicted noise term from the noised sample conditioned on a text label associated with the training data sample, e.g., ϵ_{θ}(x^{(t)}, c, t), e. g., lines 11-12 of Algorithm 1 in FIG. 6B. The second loss is computed based on a difference between the second predicted noise term and the added noise term, e.g., line 14 of Algorithm 1 in FIG. 6B, and the third loss is computed based on a difference between the third predicted noise term and the added noise term, e.g., line 13 of Algorithm 1 in FIG. 6B. In one implementation, at a training iteration, parameters of the diffusion model are updated such that the third loss conditioned on the parameters of the diffusion model is no greater than the first loss conditioned on the parameters of the diffusion model, e.g., line 15 of Algorithm 1 in FIG. 6B. The neural network model is then updated based on the computed second and third loss terms, e.g., line 17 of Algorithm 1 in FIG. 6B.

At step 604, the retrained neural network model (e.g., generative model 110b with updated parameters 115) may be deployed on one or more hardware processors (e.g., hardware platform 360 in FIG. 4) to generate the non-textual data according to the text description.

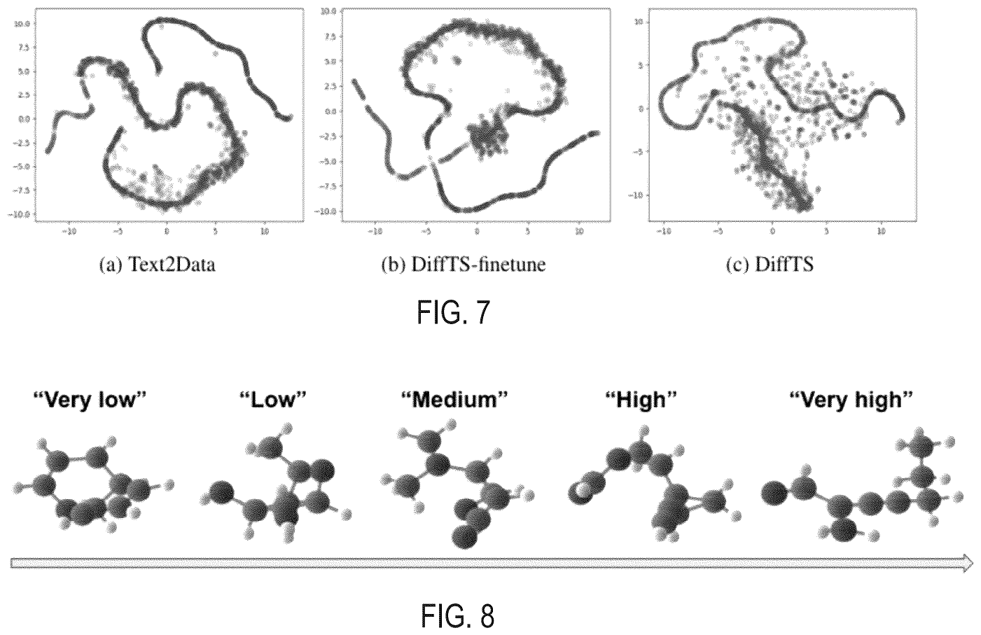

FIGS. 7-8 show example non-text data samples generated by the generative model 110 shown in FIG. 1. Specifically, low-label resource datasets used with respect to FIGS. 7-8 may comprise:

Molecules. 130,831 molecules from QM9 dataset with six molecular properties: polarizability (a), highest occupied molecular orbital energy (enoMo), lowest unoccupied molecular orbital energy (fLumo), the energy difference between HOMO and LUMO (AO, dipole moment (p) and heat capacity at 298.15K (Co).
Motions. HumanML3D that contains textually re-annotating motions captured from the AMASS and the HumanAct12 datasets. It contains 14,616 motions annotated by 44,970 textual descriptions.
Time Series. 24 stocks from Yahoo Finance are assembled during their IPO date to Jul. 8, 2023, and further tailored with the length of 120 by slicing on the opening price for every 120 days, and scale the data by min-max normalization. In total, 210,964 time series are produced. Features are extracted including frequency, skewness, mean, variance, linearity (measured by R²), and number of peaks via “tsfresh” in Python.

Each dataset is divided into training and testing sets at a ratio of 80% to 20%. Each dataset is curated to have varying proportions (i.e., 2%, 4%, 6%, 8%, 10%, 20%, 30%, 40%) of text labels in order to assess Text2Data and its baseline comparisons.

Example baseline models for comparison with the generative model Text2Data described herein include:

E(3) Equivariant Diffusion Model (EDM). EDM utilizes an equivariant network to denoise diffusion processes by concurrently processing both continuous (atom coordinates) and categorical data (atom types). The controllability of molecular properties are realized by the classifier-free diffusion guidance conditioned on the embedding of text descriptions and the number of atoms.
Motion Diffusion Model (MDM) is a classifier-free diffusion model, for text-to-human motion generation. The text descriptions are embedded to guide the motions, providing a mechanism for controllability.
Generation diffusion for time series (DiffTS) is a classifier-free diffusion model from scratch conditioned on text embeddings.
During implementation, the baselines are trained on a specific proportion of labeled data. Text2Data is modified from the baseline model with a pretraining+finetuning strategy following Eq. (6). Text2Data and the baselines are evaluated according to (1) generation quality and (2) controllability.
Generation quality. The evaluation of generation quality varies based on the modality. For molecular generation, log likelihood (−log p) and validity of generated molecules, molecular stability and atom stability are computed to evaluate their overall generation quality. For motion generation, FID score and Diversity are computed. For time series generation, t-SNE plots are drawn to visualize the overlap between generated data and the ground-truth. Better model tends to have a larger overlap, indicating more similar distribution.
Controllability, the similarity between generated data and the ground truth is used for controllability. To assess the generated molecules, a classifier is trained for each property to extract specific properties from generated data. Then, the Mean Absolute Error (MAE) is computed between the extracted property and the ground truth. To assess the controllability of motion generation, R precision and Multimodal distance that measure the relevancy of the generated motions to the input prompts are computed. To evaluate the controllability of time series generation, properties are extracted via “tsfresh” and compute the MAE between properties of generated data and that of ground truth. Additionally, generated data is visualized according to the specified properties.

FIG. 7 shows the overall quality of generating time series by making t-SNE plots of generated time series against ground truth. Substantial overlap between the generated time series and the ground truth suggests a closer distribution alignment, implying a better performance. As demonstrated in FIG. 7, the red pattern represents the t-SNE of ground-truth time series, whereas the blue pattern is the t-SNE of generated time series according to the same text description. Compared with DiffTS-finetune and DiffTS, Text2Data corresponds to the largest overlap between distributions of the generated and the ground-truth time series, suggesting its superior ability to precisely generate data according to the text description. The non-overlapping part may result from the diversity of generated time series or properties that are not controlled by text description. The inferior performance of DiffTS stems from its training solely on labeled data, potentially leading to an incomplete understanding of the overall data distribution and a risk of overfitting. DiffTS may only partially capture the data distribution based on textual descriptions due to its susceptibility to catastrophic forgetting, which also heightens the risk of overfitting.

FIG. 8 shows the molecules generated as the text descriptor for polarizability shifts from “very low” to “very high”. Polarizability indicates a molecule's inclination to form an electric dipole moment under an external electric field. As a values rise, we expect to see molecules with less symmetrical forms, as evidenced in FIG. 8.

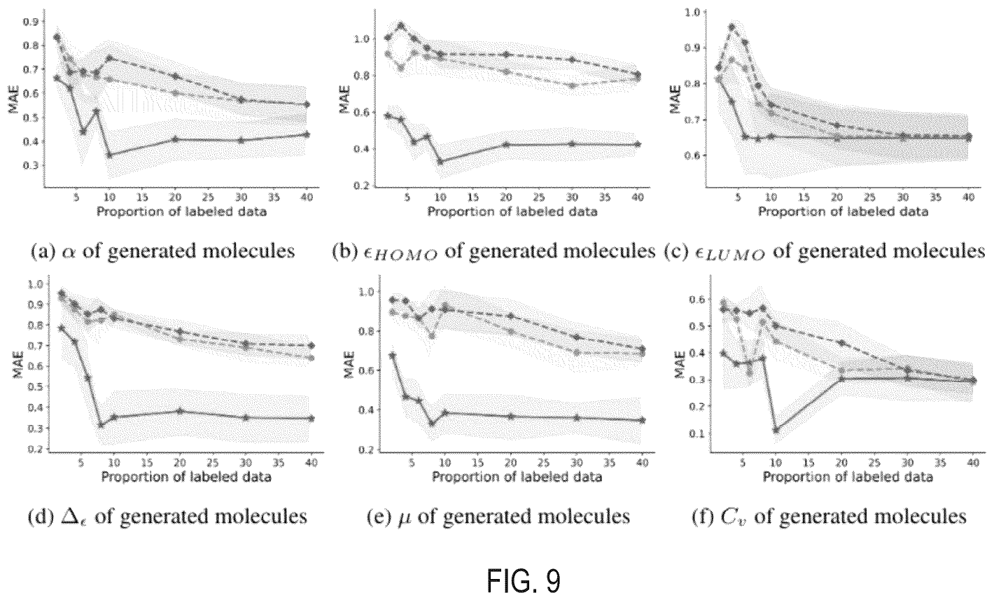

FIG. 9 illustrates the MAE trend between the specific property of generated molecules and the intended one as the proportion of labeled training data rises. Text2Data achieves superior performance than EDM-finetune and EDM on all six properties. The results also indicate that certain properties, such as E LUMO and Cv, are more readily controllable. For these properties, the performance of the three models converges as the amount of labeled training data becomes sufficiently large.

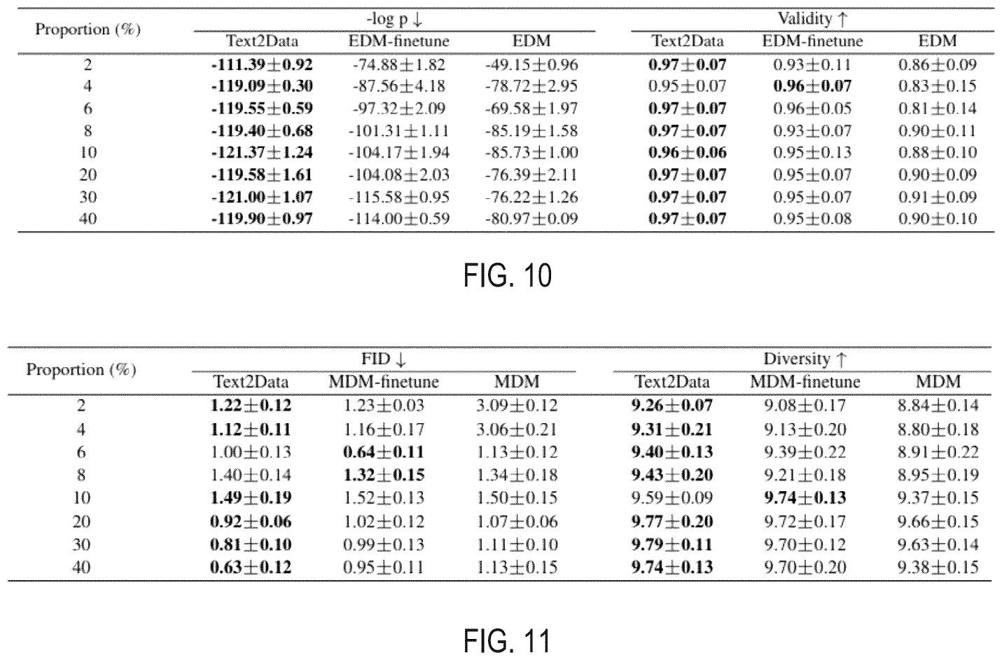

FIG. 10 compares generating molecules from Text2Data and its baseline. Metric log p and validity are computed to evaluate generation quality. The performance of Text2Data is consistently better. It surpasses EDM-finetune and EDM by average margins of 19.07% and 58.03%, respectively. It is 1.98% and 10.59% better than EDM-finetune and EDM on average, respectively, regarding validity on average. Text2Data exceeds EDM-finetune and EDM by average margin of 2.34% and 17.31%, respectively, in terms of molecular stability. It is also 0.29% and 1.21% better than EDM-finetune and EDM on average, respectively, regarding atom stability. The consistent improvements on all the three models result from our superior performance of Text2Data on properties (e.g., molecular stability) that are hard to control.

FIG. 11 evaluates generation quality on HumanML3D dataset by FID and Diversity according to different proportions of paired data. Low FID and higher diversity indicate better performance. Quantitative assessment of motion generation from text shows that Text2Data surpasses the baseline methods in both quality and diversity. Particularly, Text2Data outperforms MDM-finetune and MDM by 2.73% and 36.05% on average, respectively, regarding FID score. Regarding diversity, Text2Data surpasses MDM-finetune and MDM by average margins of 0.81% and 3.71%, respectively. Enhanced performance is derived from the ability of Text2Data to fully leverage all samples in the dataset, while effectively mitigating catastrophic forgetting during finetuning.

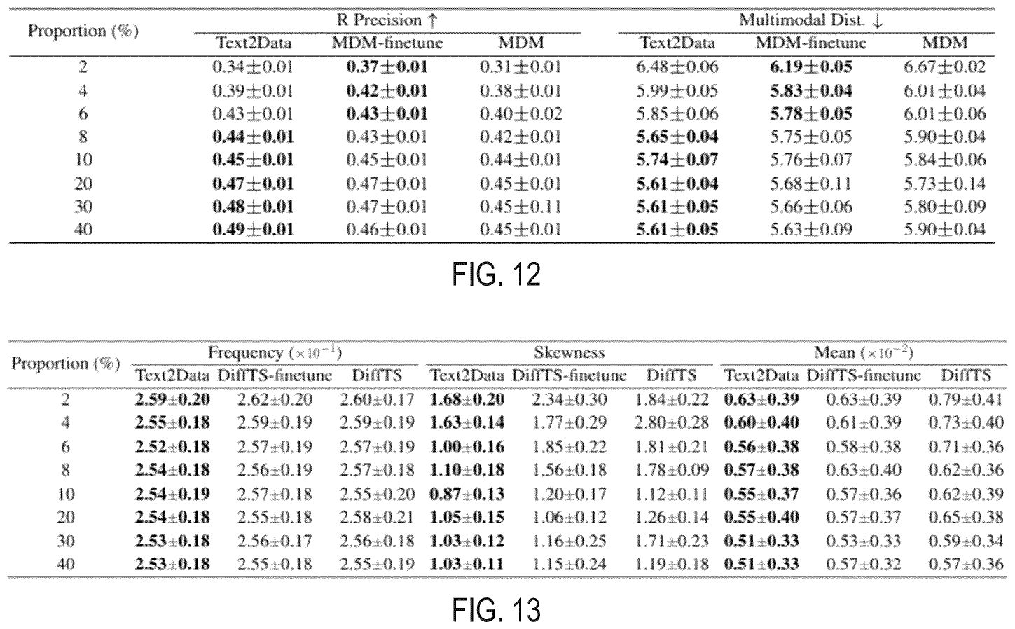

As suggested in FIG. 12, Text2Data also outperforms MDM-finetune and MDM in the controllable generation of motions from texts. While MDM-finetune is slightly better than Text2Data when the proportion of labeled training data is small-owing to milder catastrophic forgetting during finetuning with a smaller sample size-Text2Data consistently surpasses both MDM-finetune and MDM as the volume of labeled training data increases. Specifically, in this situation, Text2Data surpasses MDM-finetune and MDM in R Precision with average margins of 2.31% and 5.57%, respectively, and in Multimodal Distance with average margins of 0.93% and 3.30%, respectively. The results also indicate that an increase in labeled training data enhances the performance of controllability.

FIG. 13 shows controllability of Text2Data, along with its baseline comparisons, by utilizing MAE to measure the congruence between the property of generated data and the intended one within the Time Series dataset. As indicated in FIG. 13, Text2Data consistently excels over DiffTS-finetune and DiffTS across all three properties assessed during the study. Results of another three properties are in Appendix Table 6, which leads to similar conclusion. Specifically, Text2Data and DiffTS-finetune show a marked improvement over DiffTS in controlling frequency, variance, and skewness. They also exhibit a slight edge in controlling mean, number of peaks, and linearity. The enhanced performance of Text2Data correlates with its proficiency in alleviating the issue of catastrophic forgetting while maintaining a pursuit of controllability.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method for training a neural network model to transform a text description into non-textual data, comprising:
receiving, via a communication interface, a dataset comprising a first subset of training data without labels and a second subset of training data with labels;
training the neural network model according to a first loss computed using the first subset of training data without labels
retraining the trained neural network model according to a second loss computed using the second subset of training data with labels and according to a constraint that a third loss computing using the second subset of training data but without the labels is no greater than the first loss; and
deploying the retrained neural network model on one or more hardware processors to generate the non-textual data according to the text description.

2. The method of claim 1, wherein the neural network model comprise a diffusion model.

3. The method of claim 2, wherein the training the neural network model comprises:
adding a noise term to a training data sample from the first subset to generate a noised sample; and
iteratively predicting, by the diffusion model, a first predicted noise term from the noised sample.

4. The method of claim 3, wherein the first loss is computed based on a difference between the first predicted noise term and the added noise term.

5. The method of claim 2, wherein the retraining the neural network model comprises:
adding a noise term to a training data sample from the second subset to generate a noised sample;
iteratively predicting, by the diffusion model, a second predicted noise term from the noised sample; and
iteratively predicting, by the diffusion model, a third predicted noise term from the noised sample conditioned on a text label associated with the training data sample.

6. The method of claim 5, wherein the second loss is computed based on a difference between the second predicted noise term and the added noise term, and wherein the third loss is computed based on a difference between the third predicted noise term and the added noise term.

7. The method of claim 6, wherein the retraining the neural network model further comprises:
updating, at a training iteration, parameters of the diffusion model such that the third loss conditioned on the parameters of the diffusion model is no greater than the first loss conditioned on the parameters of the diffusion model.

8. The method of claim 1, wherein the non-textual data comprises any of:
biological structure data;
time-series data; and
video motion data.

9. A system for training a neural network model to transform a text description into non-textual data, the system comprising:
a communication interface configured to receive a dataset comprising a first subset of training data without labels and a second subset of training data with labels;
a memory storing parameters of the neural network model and processor-executable instructions; and
one or more processors executing the processor-executable instructions to perform operations comprising:
training the neural network model according to a first loss computed using the first subset of training data without labels;
retraining the trained neural network model according to a second loss computed using the second subset of training data with labels and according to a constraint that a third loss computing using the second subset of training data but without the labels is no greater than the first loss; and
deploying the retrained neural network model to generate the non-textual data according to the text description.

10. The system of claim 1, wherein the neural network model comprise a diffusion model.

11. The system of claim 10, wherein the operation of training the neural network model comprises:
adding a noise term to a training data sample from the first subset to generate a noised sample; and
iteratively predicting, by the diffusion model, a first predicted noise term from the noised sample.

12. The system of claim 11, wherein the first loss is computed based on a difference between the first predicted noise term and the added noise term.

13. The system of claim 10, wherein the operation of retraining the neural network model comprises:
adding a noise term to a training data sample from the second subset to generate a noised sample;
iteratively predicting, by the diffusion model, a second predicted noise term from the noised sample; and
iteratively predicting, by the diffusion model, a third predicted noise term from the noised sample conditioned on a text label associated with the training data sample.

14. The system of claim 13, wherein the second loss is computed based on a difference between the second predicted noise term and the added noise term, and wherein the third loss is computed based on a difference between the third predicted noise term and the added noise term.

15. The system of claim 14, wherein the operation of retraining the neural network model further comprises:
updating, at a training iteration, parameters of the diffusion model such that the third loss conditioned on the parameters of the diffusion model is no greater than the first loss conditioned on the parameters of the diffusion model.

16. A non-transitory processor-readable storage medium storing a plurality of processor-executable instructions for training a neural network model to transform a text description into non-textual data, the processor-executable instructions being executed by one or more processors to perform operations comprising:
receiving, via a communication interface, a dataset comprising a first subset of training data without labels and a second subset of training data with labels;
training the neural network model according to a first loss computed using the first subset of training data without labels retraining the trained neural network model according to a second loss computed using the second subset of training data with labels and according to a constraint that a third loss computing using the second subset of training data but without the labels is no greater than the first loss; and
deploying the retrained neural network model to generate the non-textual data according to the text description.

17. The medium of claim 16, wherein the neural network model comprise a diffusion model.

18. The medium of claim 17, wherein the operation of training the neural network model comprises:
adding a noise term to a training data sample from the first subset to generate a noised sample; and
iteratively predicting, by the diffusion model, a first predicted noise term from the noised sample.

19. The medium of claim 18, wherein the first loss is computed based on a difference between the first predicted noise term and the added noise term.

20. The medium of claim 17, wherein the operation of retraining the neural network model comprises:
adding a noise term to a training data sample from the second subset to generate a noised sample;
iteratively predicting, by the diffusion model, a second predicted noise term from the noised sample; and
iteratively predicting, by the diffusion model, a third predicted noise term from the noised sample conditioned on a text label associated with the training data sample.
